(19) United States
(12) Patent Application Publication
(10) Pub. No.: US 2021/0266229 A1
(43) Pub. Date: Aug. 26, 2021

(54) MONITORING APPARATUS, NETWORK SYSTEM, TOPOLOGY MANAGEMENT METHOD, AND COMPUTER READABLE MEDIUM

(71) Applicant: Mitsubishi Electric Corporation, Tokyo (JP)

(72) Inventors: Sachiko TANIGUCHI, Tokyo (JP); Yoshifumi HOTTA, Tokyo (JP); Ryuma MATSUSHITA, Tokyo (JP)

(73) Assignee: Mitsubishi Electric Corporation, Tokyo (JP)

(21) Appl. No.: 17/314,769

(22) Filed: May 7, 2021

Related U.S. Application Data
(63) Continuation of application No. PCT/JP2018/048484, filed on Dec. 28, 2018.

(51) Int. Cl. H04L 12/24; H04L 12/42; H04L 12/733

(52) U.S. Cl. CPC H04L 41/12; H04L 45/20; H04L 12/42

(57) ABSTRACT

An information obtaining unit (53) of a monitoring apparatus (40) obtains from each node, adjacent connection information (33) that is created in each node by an exchange of information and sharing of information between the nodes, and keeps the adjacent connection information (33) in a connection information file (38). The adjacent connection information (33) is information that indicates a connection relationship between the nodes. A topology comparison unit (54) of the monitoring apparatus (40) compares connection information included in the adjacent connection information (33) with topology definition information (59) retained in a topology definition file (58) beforehand, and determines whether or not a configuration of a ring network is according to design. The topology definition information (59) is information that defines the connection relationship between nodes in the ring network.

### CROSS REFERENCE TO RELATED APPLICATION

This application is a Continuation of PCT International Application No. PCT/JP2018/048484, filed on Dec. 28, 2018, which is hereby expressly incorporated by reference into the present application.

### TECHNICAL FIELD

The present invention relates to a monitoring apparatus, a network system, a topology management method, and a monitoring program.

### BACKGROUND ART

Available as protocols to be used in a ring network are the RPR and the ERP that multiplex a user frame in the ring network, deliver the user frame that is multiplexed to a terminal connected to the network, and carry out switching of routes within 50 ms when a network failure occurs. “RPR” is an abbreviation for Resilient Protection Ring. “ERP” is an abbreviation for Ethernet (registered trademark) Ring Protection. Standardization is completed for the RPR as IEEE 802.17 and for the ERP as ITU-T G.8023. Since there is a topology detection function based on Topology Discovery in the RPR protocol, a node is able to perform the topology detection in a ring, but there is no rule for a topology detection in a case where a multi-ring network is configured. There is no rule for a topology detection function in the ERP protocol.

In a method described in Patent Literature 1, in a case where a multi-ring network is to be configured with a conventional RPR device, in addition to the topology detection function of the RPR, information indicating that a node that makes a connection between rings is a redundant node is transmitted, and each node in the ring creates a topology table including information on this redundant node. Based on this topology table, each node delivers a packet and monitors a state.

### CITATION LIST

### Patent Literature

Patent Literature 1: JP 2006-129071 A
Patent Literature 2: JP 2013-046090 A
Patent Literature 3: JP 2009-147653 A
Patent Literature 4: WO/2011/037004
Patent Literature 5: JP 2011-515057 A

### Non-Patent Literature

Non-Patent Literature 1: Kenji KITAYAMA, “A Study on RPR for multiple network failure,” IEICE Technical Report, Japan, The Institute of Electronics, Information and Communication Engineers, 2008, Vol. 107, No. 530, pp. 15-20.

### SUMMARY OF INVENTION

### Technical Problem

In the method described in Patent Literature 1, a control frame is forwarded while a TTL field is subtracted and a hop count from a transmission source node is calculated based on a value of TTL to generate a topology table. In this method, whether or not a topology table each node retains in the ring is consistent between the nodes in the ring cannot be easily determined. “TTL” is an abbreviation for Time to Live.

The present invention aims to make confirmation of whether or not a configuration of a ring network is of a desired configuration be done easily.

### Solution to Problem

A monitoring apparatus according to one aspect of the present invention includes:

an information obtaining unit to obtain adjacent connection information
that is created in each node by an exchange of information and sharing of information between a plurality of nodes that belong to a ring network, and
that indicates a connection relationship between the nodes in the ring network and information of an inter-network node that belongs to a ring network other than the ring network,
   from the plurality of nodes; and

a topology comparison unit to compare connection information included in a plurality of pieces of adjacent connection information obtained from the plurality of nodes by the information obtaining unit with topology definition information, the topology definition information being information that is retained in a memory beforehand and that defines the connection relationship between the nodes in the ring network and the information of the inter-network node that connects the ring networks to each other, and to determine whether or not a configuration of the ring network is according to design.

### Advantageous Effects of Invention

In the present invention, by comparing adjacent connection information created in each node in a ring network with topology definition information retained in a memory beforehand, whether or not a configuration of the ring network is according to design is determined. Consequently, according to the present invention, whether or not a configuration of a ring network is of a desired configuration can be easily confirmed.

### BRIEF DESCRIPTION OF DRAWINGS

FIG. 1 is a block diagram illustrating a hardware configuration of a node device according to Embodiment 1.

FIG. 2 is a block diagram illustrating a functional configuration of the node device according to Embodiment 1.

FIG. 3 is a block diagram illustrating a hardware configuration of a monitoring apparatus according to Embodiment 1.

FIG. 4 is a block diagram illustrating a functional configuration of the monitoring apparatus according to Embodiment 1.

FIG. 5 is a diagram illustrating a configuration example of a network system according to Embodiment 1.

FIG. 6 is a table illustrating a format of adjacent node information 31 according to Embodiment 1.

FIG. 7 is a diagram illustrating an example of an exchange of adjacent node information according to Embodiment 1.

FIG. 8 is a table illustrating a format of adjacent connection information 33 according to Embodiment 1.

FIG. 9 is a table illustrating an example of sharing of adjacent connection information according to Embodiment 1.

FIG. 10 is a diagram illustrating a configuration example of the network system according to Embodiment 1.

FIG. 11 is a table illustrating an example of a topology counter table 34 according to Embodiment 1.

FIG. 12 is a diagram illustrating a state machine of the node device according to Embodiment 1.

FIG. 13 is a block diagram illustrating a hardware configuration of a node device according to a variation of Embodiment 1.

FIG. 14 is a block diagram illustrating a hardware configuration of a monitoring apparatus according to a variation of Embodiment 1.

FIG. 15 is a block diagram illustrating a functional configuration of a monitoring apparatus according to Embodiment 2.

FIG. 16 is a table illustrating an example of a topology map table 32 according to Embodiment 2.

FIG. 17 is a diagram illustrating an example of collating a topology definition file according to Embodiment 2.

### DESCRIPTION OF EMBODIMENTS

Hereinafter, embodiments of the present invention will be described using the drawings. The same or corresponding portions are denoted by the same reference numerals throughout the drawings. Descriptions of the same or corresponding portions will be suitably omitted or simplified in the description of the embodiments. The present invention is not limited to the embodiments to be described hereinafter, and various modifications are possible as necessary. For example, the embodiments to be described hereinafter may partially be carried out.

### Embodiment 1

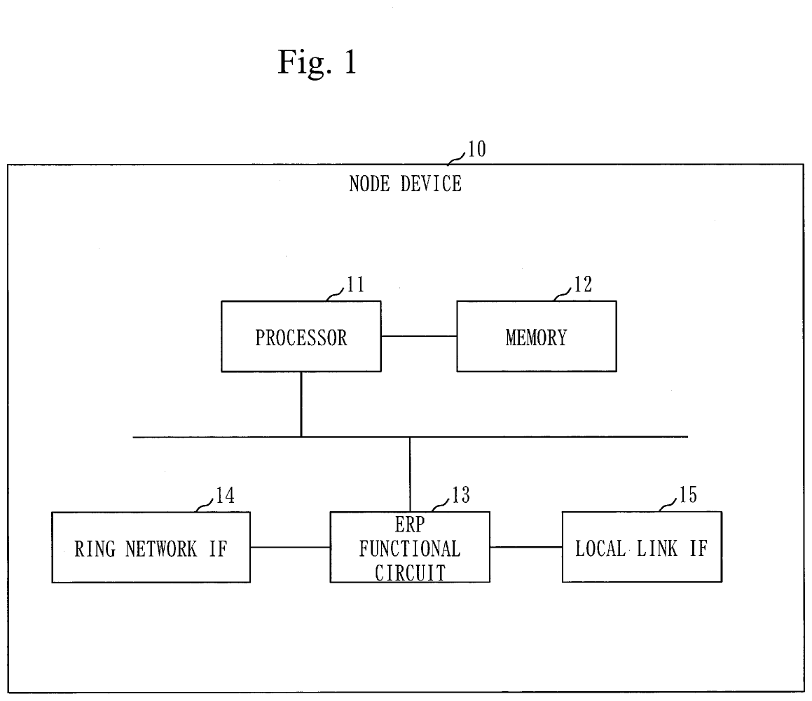

This embodiment will be described using FIG. 1 to FIG. 12.

*** Description of Configuration ***

<<<Node Device 10>>>

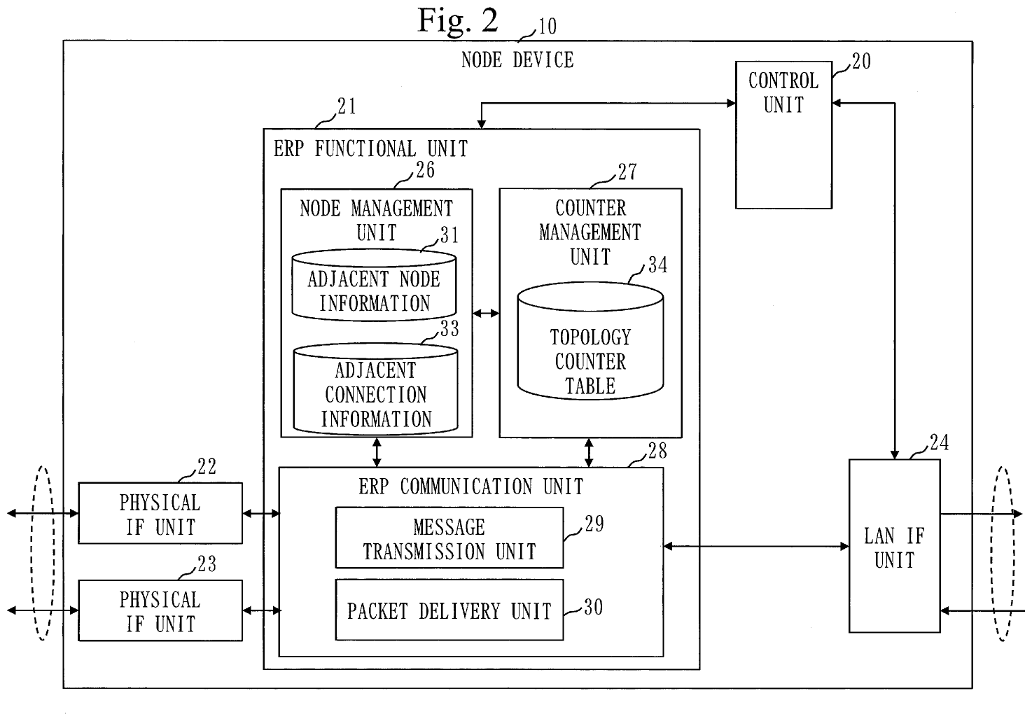

A configuration of a node device 10 according to this embodiment will be described by referring to FIG. 1 and FIG. 2.

The node device 10 is a computer.

As illustrated in FIG. 1, the node device 10 includes a processor 11 and also other hardware such as a memory 12, an ERP functional circuit 13, a ring network interface 14, and a local link interface 15. The processor 11 is connected to other hardware via signal lines and controls these other hardware.

As illustrated in FIG. 2, the node device 10 includes as functional elements, a control unit 20, an ERP functional unit 21, a physical interface unit 22, a physical interface unit 23, and a LAN interface unit 24. “LAN” is an abbreviation for Local Area Network. The ERP functional unit 21 includes a node management unit 26, a counter management unit 27, and an ERP communication unit 28. The ERP communication unit 28 includes a message transmission unit 29 and a packet delivery unit 30.

<<Control Unit 20>>

The control unit 20 controls the ERP functional unit 21. Functions of the control unit 20 are realized by software. Specifically, the functions of the control unit 20 are realized by a control program. The control program is a program that makes a computer execute processes performed by the control unit 20 as a control process. The control program may be provided being recorded in a computer-readable medium or provided being stored in a recording medium, or provided as a program product.

<<ERP Functional Unit 21>>

The ERP functional unit 21 has an ERP function. The node management unit 26 of the ERP functional unit 21 has a function to collect node information of an adjacent node connected to the node device 10. Hereinafter, the node information of an adjacent node collected from the adjacent node is called adjacent node information 31. Adjacent node information means node information of the node device 10 connected directly by a link. The counter management unit 27 of the ERP functional unit 21 has a function to calculate, as a topology counter, a unique value indicating contents of an entry of a topology counter table 34. The message transmission unit 29 of the ERP functional unit 21 has a function to frame and transmit a message that the control unit 20, the node management unit 26, and the counter management unit 27 are to use. The packet delivery unit 30 has functions (typical functions of a network switch) to separate and deliver to each functional element a frame that the control unit 20, the node management unit 26, and the counter management unit 27 are to use, and to forward a user frame to the physical interface unit 22, the physical interface unit 23, and the LAN interface unit 24. Functions of the ERP functional unit 21 are realized by the ERP functional circuit 13.

<<Interface Unit>>

The physical interface unit 22 and the physical interface unit 23 have a ring interface function for connecting to a node adjacent to the node device 10 in a ring network. Functions of the physical interface unit 22 and the physical interface unit 23 are realized by the ring network interface 14.

The LAN interface unit 24 has a local interface function for connecting to a terminal not illustrated in the drawings or for connecting to a node of a ring network other than the ring network to where the node device 10 belongs. Functions of the LAN interface unit 24 are realized by the local link interface 15. There is also a case where the LAN interface unit 24 is installed in plurality on the node device 10.

<<Hardware Configuration of Node Device 10>>

The processor 11 is a device that executes the control program. The processor 11 is, for example, a CPU. “CPU” is an abbreviation for Central Processing Unit.

The memory 12 is a device that stores the control program beforehand or temporarily. The memory 12 is, for example, a RAM, a flash memory, or a combination of these. “RAM” is an abbreviation for Random Access Memory.

Also stored in the memory 12 are the adjacent node information 31, adjacent connection information 33, and the topology counter table 34.

The ERP functional circuit 13 is a circuit that realizes the functions of the ERP functional unit 21. The ERP functional circuit 13 is, for example, a single circuit, a composite circuit, a programmed processor, a parallel programmed processor, a logic IC, a GA, an FPGA, an ASIC, or a combination of some or all of these. “IC” is an abbreviation for Integrated Circuit. “GA” is an abbreviation for Gate Array. “FPGA” is an abbreviation for Field-Programmable Gate Array. “ASIC” is an abbreviation for Application Specific Integrated Circuit.

The ring network interface 14 includes a receiver that receives data from a node adjacent to the node device 10 in the ring network and a transmitter that transmits data to the node that is adjacent. The ring network interface 14 is, for example, a communication chip or an NIC. “NIC” is an abbreviation for Network Interface Card.

The local link interface 15 includes a receiver that receives data from a node of a ring network other than the ring network to where the node device 10 belongs and a transmitter that transmits data to a node of the other ring network. The local link interface 15 is, for example, a communication chip or an NIC.

The control program is read into the processor 11 from the memory 12 and executed by the processor 11. Not only the control program but also an OS is stored in the memory 12. “OS” is an abbreviation for Operating System. The processor 11 executes the control program while executing the OS. A part or all of the control program may be built into the OS.

The control program and the OS may be stored in an auxiliary storage device. The auxiliary storage device is, for example, an HDD, a flash memory, or a combination of these. “HDD” is an abbreviation for Hard Disk Drive. In a case where the control program and the OS are stored in the auxiliary storage device, the control program and the OS are loaded into the memory 12 and executed by the processor 11.

The node device 10 may include a plurality of processors that replace the processor 11. These plurality of processors share execution of the control program. Each processor is, for example, a CPU.

Data, information, signal values, and variable values used, processed, or outputted by the control program are stored in the memory 12, the auxiliary storage device, or a register or a cache memory in the processor 11.

<<<Monitoring Apparatus 40>>>

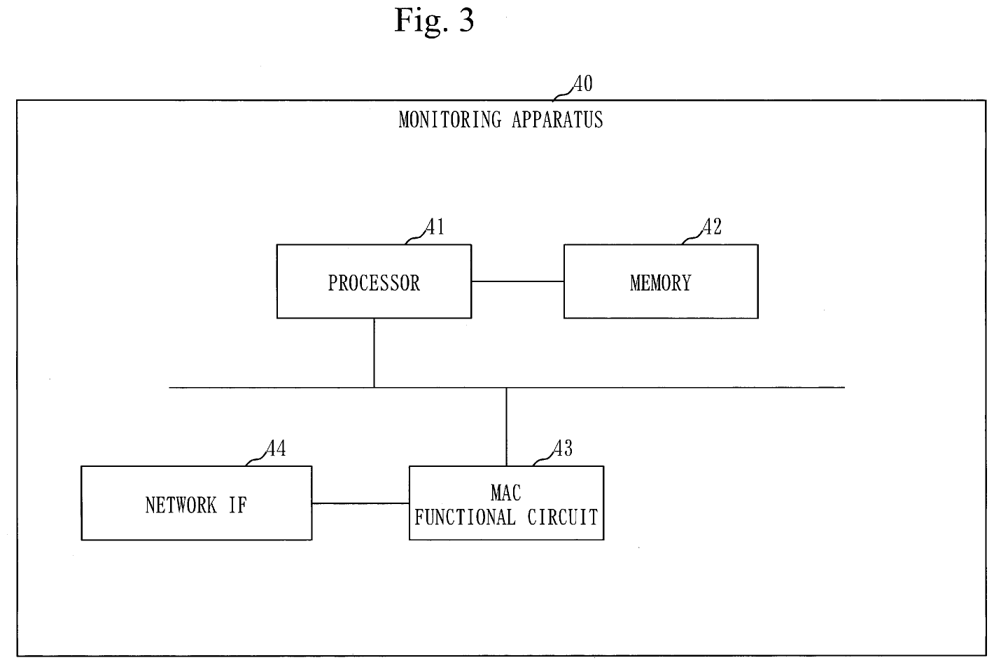

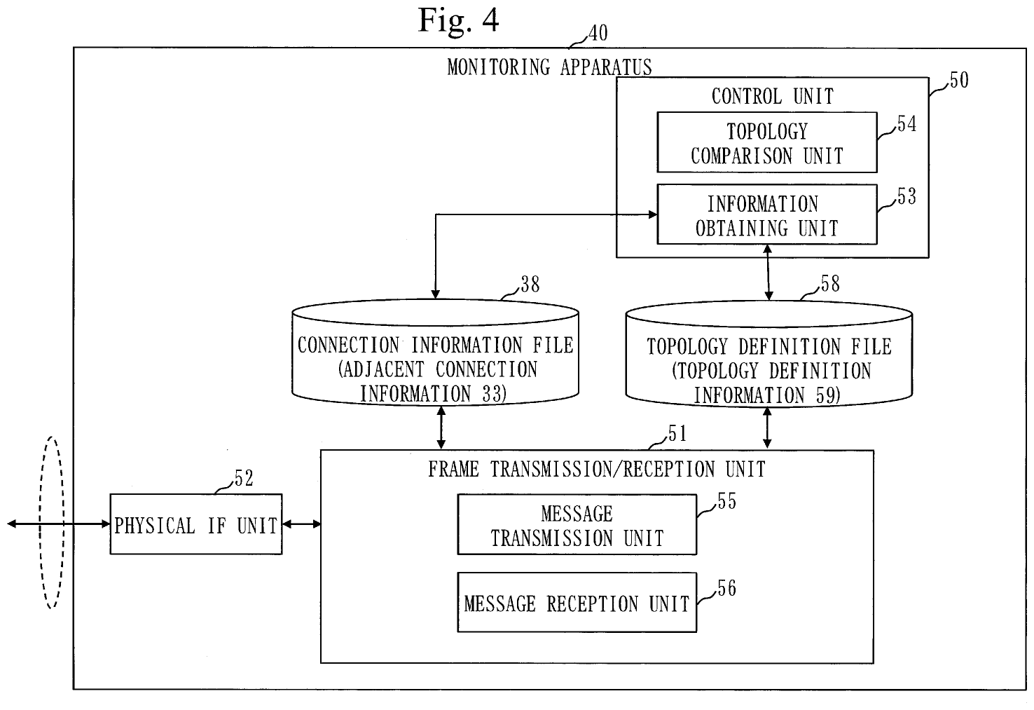

A configuration of a monitoring apparatus 40 according to this embodiment will be described by referring to FIG. 3 and FIG. 4.

The monitoring apparatus 40 is a computer.

As illustrated in FIG. 3, the monitoring apparatus 40 includes a processor 41 and also other hardware such as a memory 42, a MAC functional circuit 43, and a network interface 44. “MAC” is an abbreviation for Media Access Control. The processor 41 is connected to other hardware via signal lines and controls these other hardware.

As illustrated in FIG. 4, the monitoring apparatus 40 includes, as functional elements, a control unit 50, a frame transmission/reception unit 51, and a physical interface unit 52. The control unit 50 includes an information obtaining unit 53 and a topology comparison unit 54. The frame transmission/reception unit 51 includes a message transmission unit 55 and a message reception unit 56.

<<Control Unit 50>>

The information obtaining unit 53 of the control unit 50 has a function to control the frame transmission/reception unit 51 to give instructions to transmit/receive a command frame for obtaining necessary node information from the node device 10. The topology comparison unit 54 of the control unit 50 has a function to periodically compare topology definition information recorded in a topology definition file 58 beforehand with information in a connection information file 38 which has recorded node information collected from the node device 10, and output a comparison result. An output format of the comparison result may be in any format, but in this embodiment, a format to display the comparison result on a screen of a display not illustrated in the drawings is used. The comparison result, specifically, is a confirmation result of whether or not the topology definition information recorded in the topology definition file 58 and the node information recorded in the connection information file 38 match. Functions of the control unit 50 are realized by software. Specifically, the functions of the control unit 50 are realized by a monitoring program. The monitoring program is a program that makes a computer execute processes performed by the information obtaining unit 53 and the topology comparison unit 54 as an information obtaining process and a topology comparison process, respectively. The monitoring program may be provided being recorded in a computer-readable medium, provided being stored in a recording medium, or provided as a program product.

<<Frame Transmission/Reception Unit 51>>

The frame transmission/reception unit 51 has a function to transmit/receive a command frame for collecting the node information from the node device 10 and to write the node information collected into the connection information file 38 according to instructions from the control unit 50. The message transmission unit 55 of the frame transmission/reception unit 51 has a function to generate and transmit a message for collecting information to the node device 10 according to instructions from the control unit 50. The message reception unit 56 of the frame transmission/reception unit 51 has a function to take out node information from a message received from the node device 10 and write the node information into the connection information file 38. Functions of the frame transmission/reception unit 51 are realized by the MAC functional circuit 43.

<<Interface Unit>>

The physical interface unit 52 has an interface function to connect to the node device 10. The functions of the physical interface unit 52 are realized by the network interface 44.

<<Hardware Configuration of Monitoring Apparatus 40>>

The processor 41 is a device that executes the monitoring program. The processor 41 is, for example, a CPU.

The memory 42 is a device that stores the monitoring program beforehand or temporarily. The memory 42 is, for example, a RAM, a flash memory, or a combination of these.

Also stored in the memory 42 are, the connection information file 38 and the topology definition file 58.

The MAC functional circuit 43 is a circuit that realizes the functions of the frame transmission/reception unit 51. The MAC functional circuit 43 is, for example, a single circuit, a composite circuit, a programmed processor, a parallel programmed processor, a logic IC, a GA, an FPGA, an ASIC, or a combination of some or all of these.

The network interface 44 includes a receiver that receives data from each node of the ring network to where the node device 10 belongs and a transmitter that transmits data to each node of the ring network. The network interface 44 is, for example, a communication chip or an NIC.

The monitoring program is read into the processor 41 from the memory 42 and executed by the processor 41. Not only the monitoring program but also the OS is stored in the memory 42. The processor 41 executes the monitoring program while executing the OS. A part or all of the monitoring program may be built into the OS.

The monitoring program and the OS may be stored in the auxiliary storage device. The auxiliary storage device is, for example, an HDD, a flash memory, or a combination of these. In a case where the monitoring program and the OS are stored in the auxiliary storage device, the monitoring program and the OS are loaded into the memory 42 and executed by the processor 41.

The monitoring apparatus 40 may include a plurality of processors that replace the processor 41. These plurality of processors share execution of the monitoring program. Each processor is, for example, a CPU.

Data, information, signal values, and variable values used, processed, or outputted by the monitoring program are stored in the memory 42, the auxiliary storage device, or a register or a cache memory in the processor 41.

<<<Network System 60>>>

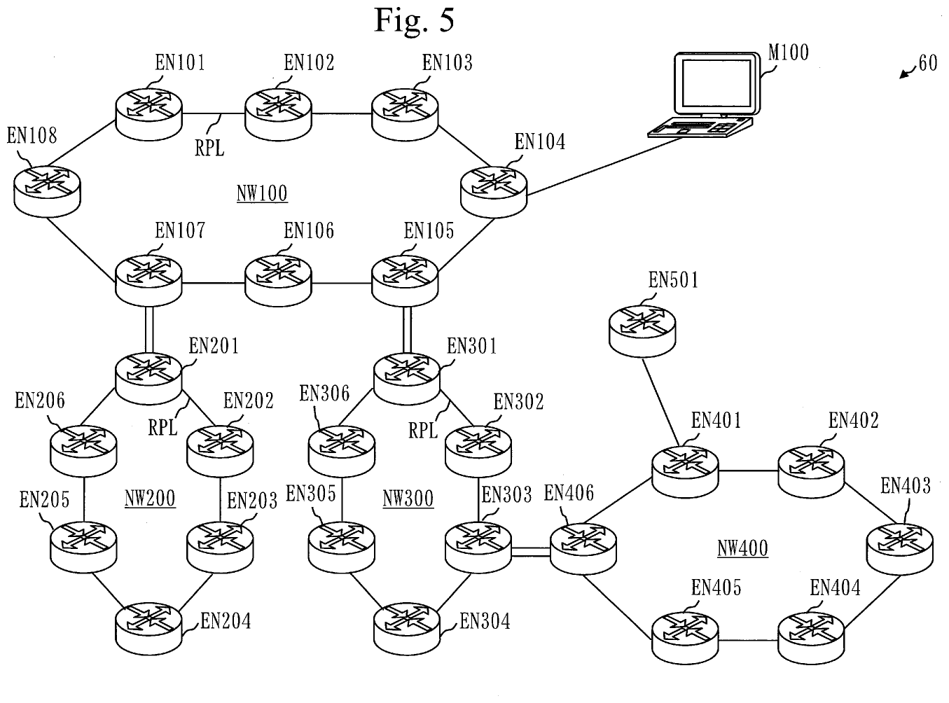

A configuration example of a network system 60 according to this embodiment will be described by referring to FIG. 5.

The network system 60 includes the monitoring apparatus 40 and a plurality of node devices 10 that are nodes of the ring network.

In the network system 60 exemplified in FIG. 5, M100 is a monitoring apparatus 40. NW100, NW200, NW300, and NW400 are ring networks. EN101 to EN108 are ERP nodes that configure NW100. EN201 to EN206 are ERP nodes that configure NW200. EN301 to EN306 are ERP nodes that configure NW300. EN401 to EN406 are ERP nodes that configure NW400. Each ERP node is a node device 10.

In the network system 60 exemplified in FIG. 5, NW100 and NW200 are connected through EN107 and EN201. NW100 and NW300 are connected through EN105 and EN301. NW300 and NW400 are connected through EN303 and EN406. In a multi-ring network, a network to which a plurality of rings are connected as described, the adjacent node information 31 and the adjacent connection information 33 of the ring network are generated in each ERP node by exchanging information between the ERP nodes. Then, M100 reads the adjacent connection information 33 generated in each ERP node and confirms whether or not the network built is connected according to network design.

With regard to node types of nodes exemplified in FIG. 5, there are those as follows.

RPL owner node: an owner node that is not connecting ring networks to each other (EN101).

RPL adjacent node: a node adjacent to an RPL owner node and a node that is not connecting ring networks to each other (EN102).

General node: a node other than an RPL owner node and an RPL adjacent node (EN103, EN104).

Inter-network node: a general node that connects ring networks to each other (EN105, EN107).

Out-of-ring node: a node that is not forming a ring network (EN501). There are cases where out-of-ring nodes are serially connected in tiers.

Inter-network connection and RPL owner node: an owner node that is connecting ring networks to each other (EN201).

Inter-network connection and RPL adjacent node: a node adjacent to an RPL owner node and a node that is connecting ring networks to each other (EN301).

*** Description of Operation ***

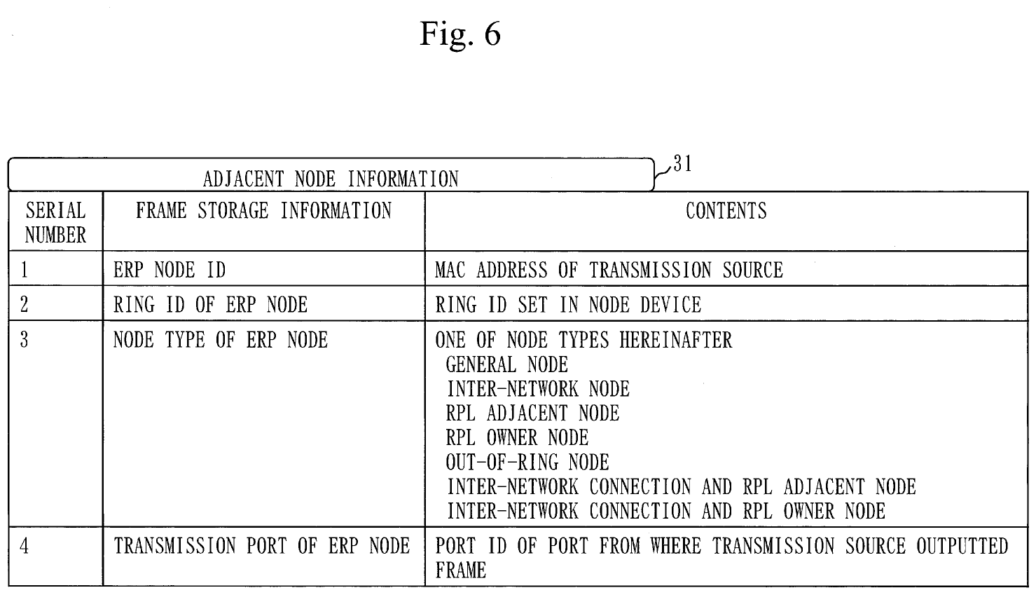

Operation of the network system 60 according to this embodiment will be described by referring to FIG. 6 to FIG. 12 in addition to FIG. 1 to FIG. 5. The operation of the network system 60 corresponds to a topology management method according to this embodiment.

<<Collecting Adjacent Node Information 31>>

Operation of the node device 10 collecting the adjacent node information 31 will be described using the example in FIG. 5. The operation to be described hereinafter is operation of a node that belongs to NW100, but the nodes that belong to NW200, NW300, and NW400 also operate similarly. In the example in FIG. 5, the ring network interface 14 is used for a ring network connection and the local link interface 15 is used for a connection between rings.

In an ERP network, there are generally an RPL owner node, an RPL adjacent node, and other nodes. “RPL” is an abbreviation for Ring Protection Link. In this embodiment, the other nodes are called general nodes. The general nodes such as EN107, EN105, and the like in NW100 that connect the ring networks to each other are called inter-network nodes.

In NW100, EN101 is an RPL owner node. EN102 is an RPL adjacent node. EN103 to EN108 are general nodes. In an ERP ring network, a line that directly connects the RPL owner node and the RPL adjacent node is called an RPL and is a block link that is not used in a normal communication. In the example in FIG. 5, a line between EN101 and EN102 is an RPL.

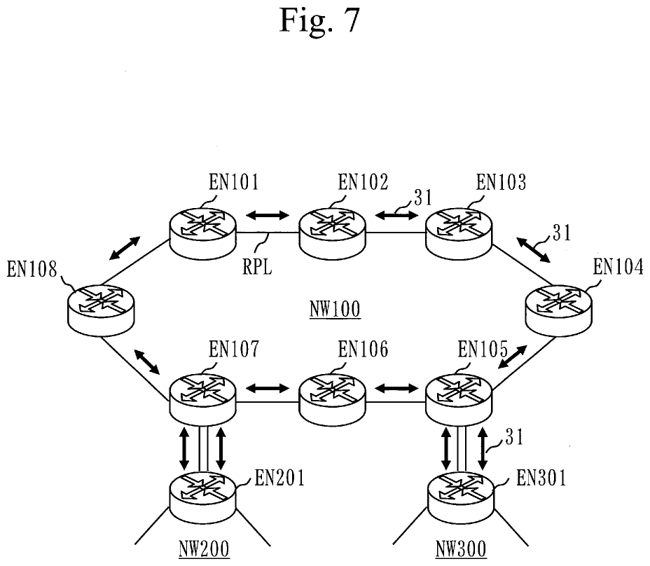

After being started, the node device 10 periodically transmits/receives the adjacent node information illustrated in FIG. 6 by Link-by-Link as illustrated by double sided arrows in FIG. 7 and collects the adjacent node information 31. In this embodiment, the adjacent node information 31 is also transmitted/received in a block link specific to the ERP network. The adjacent node information 31 received from the adjacent node is written into the memory 12.

In the example in FIG. 5, node information of EN102 and EN108 is collected in EN101 as the adjacent node information 31. In EN107, node information of EN106, EN108, and EN201 are collected as the adjacent node information 31.

In the example in FIG. 5, node information of EN501 is collected in EN401 as the adjacent node information 31.

The plurality of node devices 10 perform an exchange of information between the nodes adjacent to each other via both a block link and remaining links of the links between the nodes adjacent to each other.

Meant by the block link is a link blocked in a normal condition to avoid a loop or a link blocked at a time of failure recovery to avoid a loop.

Meant by the block link, a link blocked in a normal condition to avoid a loop, is a link between an owner node, which is one of the nodes that belong to the ring network, and an adjacent node adjacent to the owner node. In this embodiment, the RPL corresponds to the block link in a normal condition.

The block link blocked at a time of failure recovery to avoid a loop is a link where there is a possibility of communication being unstable, and is a link between a failure recovery node, which is one of the nodes that belong to the ring network, and an adjacent node adjacent to the failure recovery node.

The plurality of node devices 10 perform the exchange of information between the nodes adjacent to each other also via a link between, of the nodes that belong to the ring network, a node connected to an inter-network node that belongs to a ring network other than the ring network and the inter-network node.

When the node device 10 detects that a general node having a different ring ID has become connected to the local link interface 15 based on the adjacent node information, the node device 10 identifies an attribute of the node device 10 as an inter-network node. “ID” is an abbreviation for Identifier.

<<Generation of Adjacent Connection Information 33>>

Operation of the node device 10 generating the adjacent connection information 33 will be described.

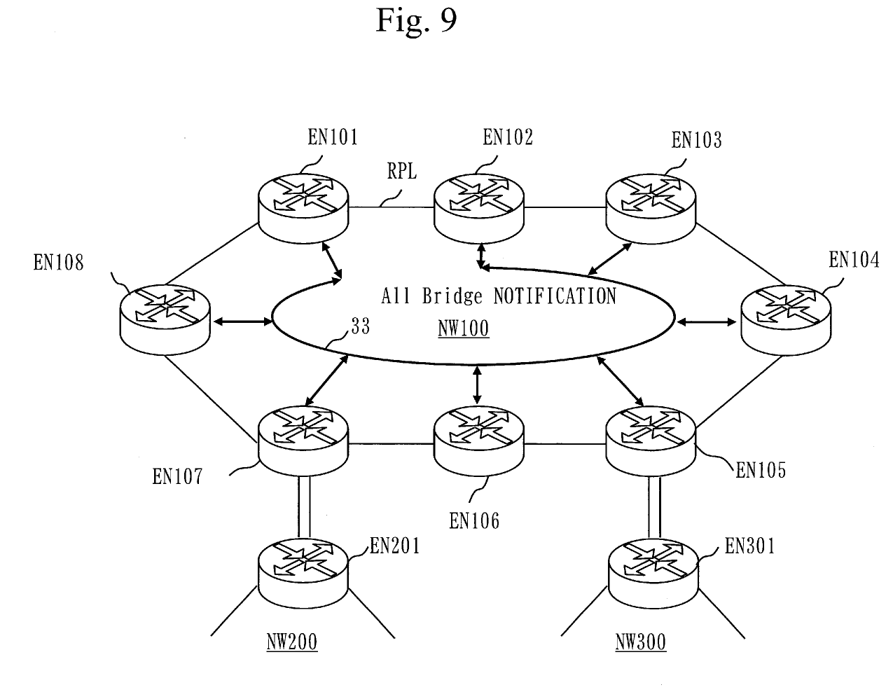

After an adjacent connection state has been made steady, every node device 10 transmits/receives the adjacent node information 31 illustrated in FIG. 6 by All Bridge on a main line of a ring as in FIG. 9 and collects the adjacent node information 31 that other nodes generated. The adjacent node information 31 received from the other nodes in the ERP network is written into the memory 12 as the adjacent connection information 33.

The adjacent connection information 33 is connection information indicating a connection relationship between the nodes in the ring network and information of an inter-network node that belongs to a ring network other than the ring network.

In the example in FIG. 9, EN101 transmits the adjacent node information 31 of EN102 and EN108 to all other nodes. EN107 transmits the adjacent node information 31 of EN106, EN108, and EN201 to all other nodes.

Each node that received the adjacent node information 31 of EN102 and EN108 from EN101 generates the adjacent connection information 33 having a transmission source ERP node as EN101, an adjacent node count as 2, and an adjacent ERP as EN102 and EN108.

Each node that received the adjacent node information 31 of EN106, EN108, and EN201 from EN107 generates the adjacent connection information 33 having the transmission source ERP node as EN107, the adjacent node count as 3, and the adjacent ERP as EN106, EN108, and EN201. Information of serial numbers 5 to 8 of the adjacent connection information 33 is generated from information of serial numbers 1 to 4 of the adjacent node information 31.

Although not illustrated in FIG. 9, the node device 10 also transmits node information obtained from an out-of-ring node to all other nodes as the adjacent node information 31.

In this embodiment, a frame in the adjacent node information 31 that the other nodes generated is not sent out to the block link. Since there is a case where the block link is a link blocked at a time of failure recovery to avoid a loop, and there is a possibility of communication being unstable in the block link, the frame in the adjacent node information 31 is not transmitted/received through the block link.

As described, the node device 10 performs sharing of information by notifying each node of the information obtained by the exchange of information via the remaining links excluding the block link.

<<Generation of Topology Counter Table 34>>

After the node device 10 generates the adjacent connection information 33, the counter management unit 27 generates the topology counter table 34.

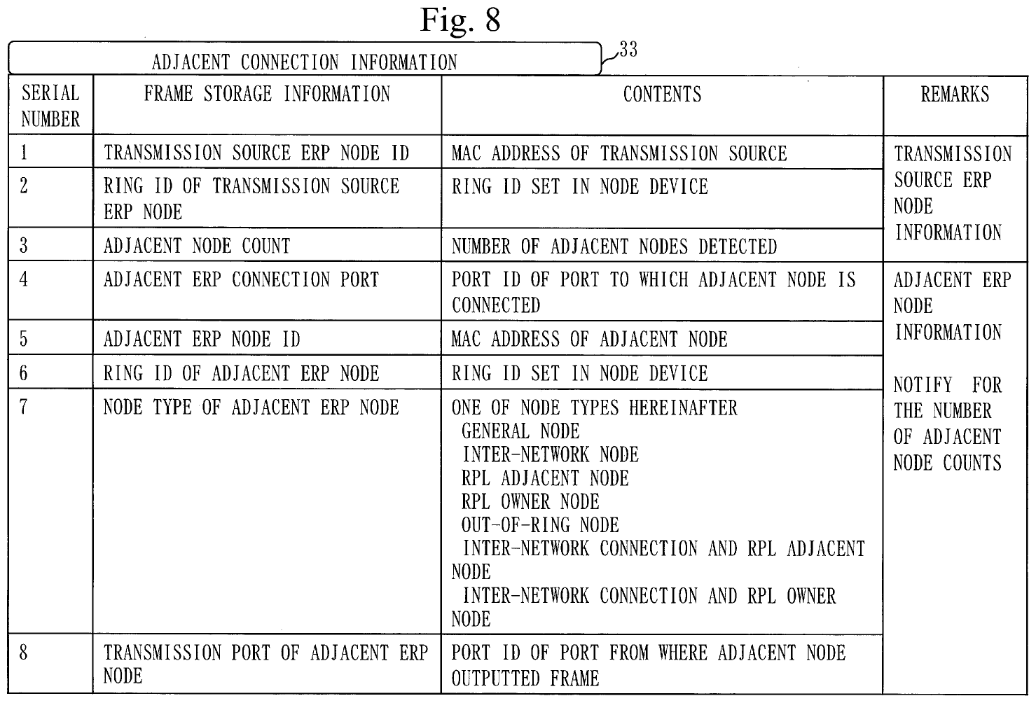

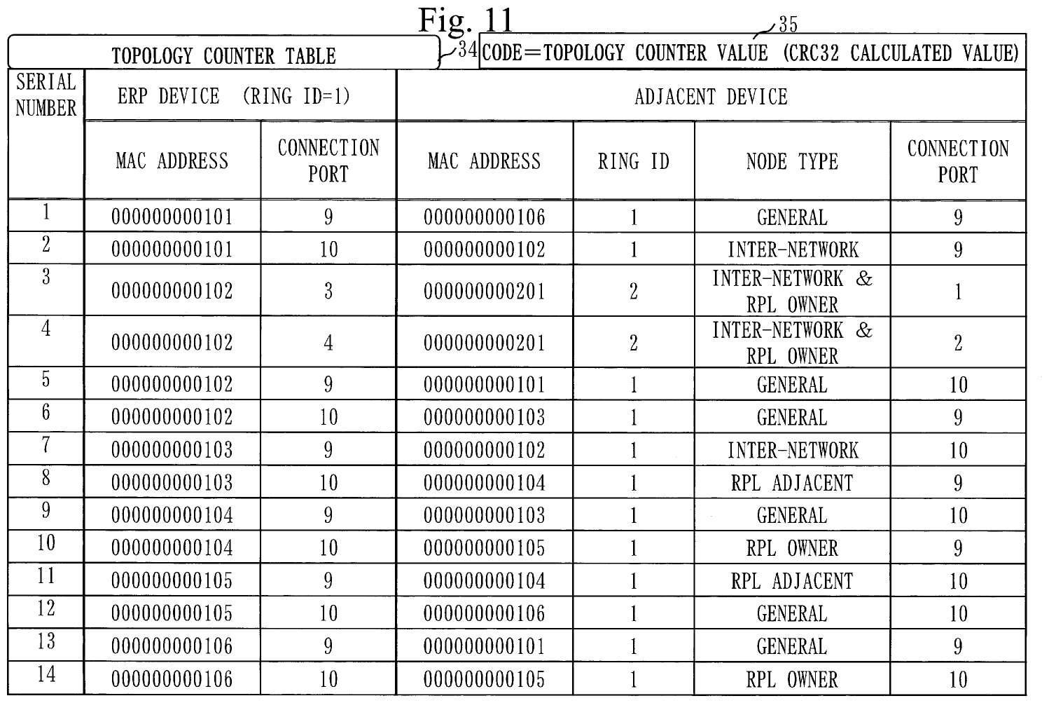

The counter management unit 27 takes out an item corresponding to six items illustrated in FIG. 11, from information of serial number 1 and serial numbers 4 to 8 illustrated in FIG. 8, and generates the topology counter table 34 in MAC address order.

Furthermore, the counter management unit 27 calculates a unique value such as a CRC32, a hash value, or the like of the topology counter table 34 as a topology counter value 35. The topology counter value 35 is a unique value or a code used for confirming consistency of a ring topology. The unique value such as a CRC32, a hash value, or the like is an example of the code. The MAC address order may be in descending order, but in this embodiment, the MAC address order is in ascending order.

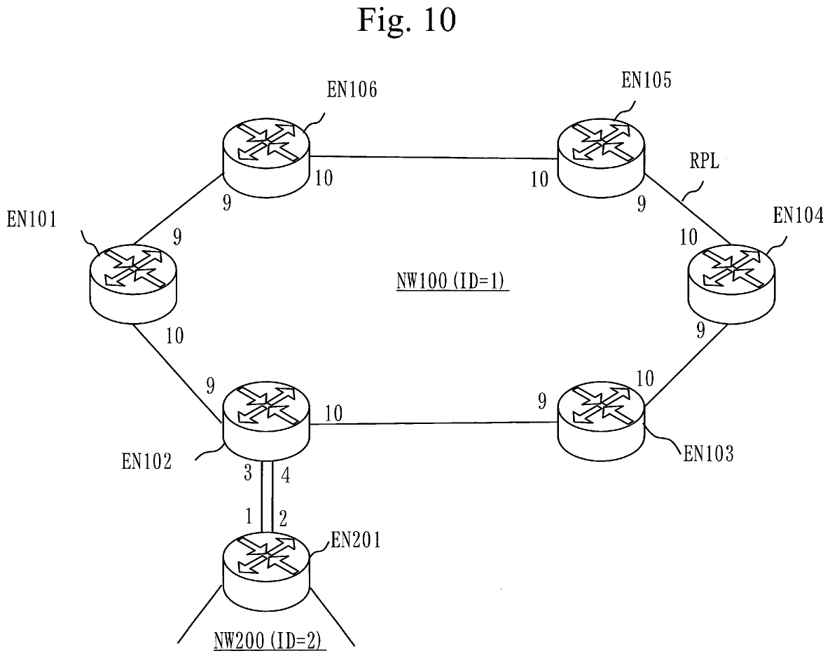

FIG. 11 illustrates the topology counter table 34 created by the counter management unit 27 in a case where the ring network is as illustrated in FIG. 10. In FIG. 10, numbers put on ends of links are port numbers of connection ports.

The counter management unit 27 of each node device 10 from EN101 to EN106 illustrated in FIG. 10 creates the topology counter table 34 illustrated in FIG. 11. The topology counter table 34 is a table indicating every “Adjacent Device” that is adjacent to every “ERP Device” in a ring network with ring ID=1.

For example, indicated in serial number 1 is that EN101 and EN106 are connected.

Information in serial number 1 is information that EN101 obtained from port number 9.

Indicated in serial number 2 is that EN101 and EN102 are connected.

Information in serial number 2 is information that EN101 obtained from port number 10.

Indicated in serial number 3 is that EN102 and EN201 are connected.

Information in serial number 3 is information that EN102 obtained from port number 3.

Indicated in serial number 4 is that EN102 and EN201 are connected.

Information in serial number 4 is information that EN102 obtained from port number 4.

As described, the topology counter table 34 is what indicates information of “Adjacent Device” obtained from every connection port that the node device 10 is using.

The topology counter table 34 is not required to have every item illustrated in FIG. 11. The topology counter table 34 may have only “MAC Address” and “Connection Port” of “ERP Device”. The topology counter table 34 may have only “MAC Address” of “ERP Device” and “MAC Address” of “Adjacent Device”.

The topology counter table 34 does not have to be in MAC address order as long as the node device 10 that belongs to a plurality of ring networks arranges information necessary for confirming consistency of a ring topology in a same order in accordance with a same rule.

The topology counter value 35 does not have to be calculated using every item in the topology counter table 34 as long as the topology counter value 35 is calculated using some of the items in the topology counter table 34. The topology counter value 35 is preferable to be calculated with “MAC Address” and “Connection Port” of “ERP Device” illustrated in FIG. 11 being included. The topology counter value 35 is preferable to be calculated with at least “MAC Address” of “ERP Device” and “MAC Address” of “Adjacent Device” illustrated in FIG. 11 being included.

As described, a plurality of node devices encode the information obtained by the exchange of information and the sharing of information with a common procedure, notify each node of a code obtained via the remaining links, and in a case where the codes obtained in every node match, each of every node being a node that configures the ring and that exchanges information and shares information, the plurality of node devices determine that a topology is decided upon.

The counter management unit 27 of the node device 10 transmits/receives the unique value calculated as the topology counter value 35 by All Bridge on the main line of the ring, and compares the unique value that the node device 10 calculated with a unique value the other node calculated. In a case where the values are the same, the node device 10 recognizes that every ERP entry in the ring is detected.

After confirming that unique values received from all other nodes on the main line of the ring are the same as the value calculated in the node device 10, the node device 10 transmits to a monitoring apparatus, match information indicating that the adjacent connection information 33 and the unique value matched.

In the adjacent connection information 33 that the node device 10 generated, connection information of an ERP node with a different ring ID is included. In the example in FIG. 11, connection information of EN201 is included.

Topology detection operation of the node device 10 will be described on a more detailed level.

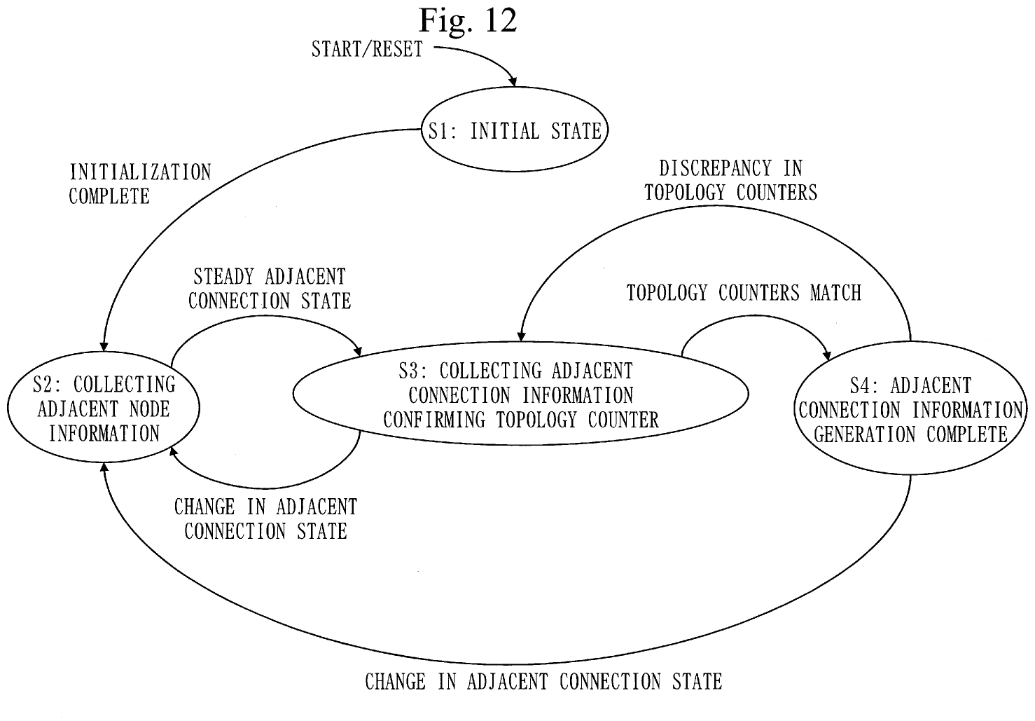

FIG. 12 illustrates a state machine to be implemented on the control unit 20 of the node device 10.

<<State S1>>

State 51 is an initial state. The initial state is a state where ERP initialization is performed. In this state, a switch port is set to a learning state, a forwarding table is cleared, and an ERP daemon is started.

<<State S2>>

State S2 is a state where the node device 10 detects an ERP node that is adjacent. In this state, as illustrated in FIG. 7, operation to periodically transmit adjacent node information by Link-by-Link is started. In this state S2, every node device 10 transmits node information of itself only to the node device 10 that is adjacent as adjacent node information. An ID specific to the node device 10 is included in the adjacent node information. Thereby, an adjacent node is notified that a transmission source is the node device 10.

Furthermore, an adjacent ERP detection function is started in this state S2. Thereby, the adjacent node information 31 is received from an adjacent node, and the adjacent connection information 33 in the format illustrated in FIG. 6 is generated and stored in a memory. Specifically, information indicating a MAC address, a ring ID, a node type, and a frame transmission port of a transmission source node is stored. Of the ring ID and the node type, as for the RPL owner node and the RPL adjacent node, values set by a maintenance person are notified. The node type is one of an RPL owner node, an RPL adjacent node, an inter-network node, a general node, an out-of-ring node, an inter-network connection and an RPL adjacent node, and an inter-network connection and an RPL owner node. In a case where the node device 10 detects an ERP node connected to any LAN port, the node device 10 recognizes the node as an inter-network node. The node device 10 selects a node type in order of priority, an inter-network connection and an RPL owner node=an inter-network connection and an RPL adjacent node>an RPL owner node=an RPL adjacent node>an inter-network node>a general node>an out-of-ring node.

<<State S3>>

State S3 is a state where the node device 10 detects other ERP nodes excluding the ERP node that is adjacent. In this state, as illustrated in FIG. 9, operation to transmit/receive the adjacent connection information 33 and the topology counter value 35 between each other in every node device 10 by All Bridge on a main line of a ring is started.

Furthermore, in this state S3, the counter management unit 27 is enabled. In the counter management unit 27, after the adjacent connection information 33 that the other node generated is received, the information of serial numbers 4 to 8 illustrated in FIG. 8 are managed in MAC address order in the table, and a CRC32 or a hash value of the topology counter table 34 is calculated as the topology counter value 35. The MAC address order may be in descending order, but in this embodiment, the MAC address order is in ascending order. The topology counter value 35 periodically forwarded by All Bridge from a node on the main line of the ring and the topology counter value 35 calculated by the counter management unit 27 are collated.

The node device 10 may transmit the adjacent connection information 33 and the topology counter value 35 in one frame or may transmit the adjacent connection information 33 and the topology counter value 35 in separate frames. In a case where the adjacent connection information 33 and the topology counter value 35 are to be transmitted in one frame, a processing load of the node device 10 is reduced, and furthermore, a communication load of a network is reduced.

Every time the adjacent connection information 33 and the topology counter value 35 are received, the control unit 20 of the node device 10 updates the topology counter table 34 with the adjacent connection information 33 received, and updates the topology counter value 35. The control unit 20 compares the topology counter value 35 received with the topology counter value 35 of itself that was updated.

The control unit 20 tests whether or not every topology counter value 35 periodically forwarded from every node device 10 matches the topology counter value 35 of itself.

In a case where the control unit 20 was able to confirm that every topology counter value 35 being periodically forwarded and the topology counter value 35 of itself match, the control unit 20 determines that there is consistency in the ring topology, and notifies the monitoring apparatus 40 of the adjacent connection information 33 and match information indicating that the topology counter values 35 match.

The control unit 20 does not have to receive the adjacent connection information 33 and the topology counter value 35 from every node device 10.

The reason is because since the topology counter table 34 has interconnection information of the node device 10, there is a case where, from information of one side, information of another can be generated.

For example, in FIG. 10, in a case where the adjacent connection information 33 and information on the topology counter value 35 from EN104 were not forwarded, information of serial number 9 and serial number 10 in FIG. 11 will be missing.

The information of serial number 9, however, can be generated from information of serial number 8 and serial number 6.

The information of serial number 10 can be generated from information of serial number 11 and serial number 14.

In a case where information was not being forwarded from a certain node device 10, the control unit 20 generates, by using adjacent connection information 33 of another node device, information of the topology counter table 34 for the certain node device 10 and completes the topology counter table 34.

In a case where the information of the topology counter table 34 for the certain node device 10 is able to be completely generated, since the topology counter values 35 match, the control unit 20 notifies the monitoring apparatus 40 of the adjacent connection information 33 and the match information indicating that the topology counter values 35 matched.

In a case where the information of the topology counter table 34 for the certain node device 10 could not be completely generated, since there will be a discrepancy in the topology counter values 35, forwarding of the information from the node device 10 becomes waited for and state S3, in which adjacent connection information is being collected, continues.

<<State S4>>

State S4 is a state where topology generation in the ring network is completed. In a case where a discrepancy is found in the topology counters again, a transition to state S3 occurs. In a case where a change in the adjacent connection state such as a broken link, an addition of an adjacent node, or the like are detected, a transition to state S2 occurs.

The node device 10 transmits following information in each state.

S2: Transmits node information of itself as adjacent node information only to a node device 10 that is adjacent.

S3: Transmits the adjacent connection information 33 and the topology counter value 35 to every node device 10.

S4: Transmits the adjacent connection information 33 and the match information of the topology counter values 35 to the monitoring apparatus 40.

As described above, the plurality of node devices 10 of the network system 60 create the adjacent node information 31 and the adjacent connection information 33 based on information obtained by the exchange of information and the sharing of information between the nodes that belong to the ring network. In this embodiment, the information obtained by each node device 10 by the exchange information and the sharing of information is stored in the memory 12 as the adjacent node information 31 and the adjacent connection information 33.

The plurality of node devices 10 of the network system 60 perform the exchange of information of the adjacent node information 31 between the nodes adjacent to each other via both a block link and remaining links of the links between the nodes adjacent to each other.

The plurality of node devices 10 of the network system 60 perform the exchange of information of the adjacent node information 31 between the nodes adjacent to each other also via a link between, of the nodes that belong to the ring network, a node connected to an inter-network node that belongs to a ring network other than the ring network and the inter-network node.

The plurality of node devices 10 of the network system 60 perform the exchange of information of the adjacent node information 31 between the nodes adjacent to each other also via a link between, of the nodes that belong to the ring network, a node connected to an out-of-ring node that does not belong to a ring network and the out-of-ring node.

The plurality of node devices 10 of the network system 60 generate the adjacent connection information 33 based on the adjacent node information 31 obtained by the exchange of information, and perform the sharing of information by notifying each node of the adjacent connection information 33 via the remaining links in each ring network excluding the block link.

In a case where there is an out-of-ring node, the sharing of information is performed also with the out-of-ring node, and the sharing of information of the adjacent connection information 33 is performed also with the out-of-ring node.

The plurality of node devices 10 of the network system 60 encode the adjacent connection information 33 obtained by the exchange of information and the sharing of information with a common procedure, and notify each node of a code obtained via the remaining links in each ring network. In this embodiment, the topology counter value 35 such as a CRC32, a hash value, or the like is calculated as the code.

In a case where there is an out-of-ring node, the topology counter value 35 is calculated also in the out-of-ring node.

<<<Monitoring Apparatus 40>>>

The monitoring apparatus 40 has every piece of topology information of NW100, NW200, NW300, and NW400 beforehand. From the plurality of node devices 10 that belong to NW100, NW200, NW300, and NW400, the monitoring apparatus 40 collects the adjacent connection information 33 that these plurality of node devices 10 generated and the match information of the topology counter values 35. The monitoring apparatus 40 confirms the match information of the topology counter values 35 collected and furthermore, confirms whether or not an entire multi-ring network is of a desired network configuration by collating the adjacent connection information 33 with the topology information that the monitoring apparatus 40 has.

<<Information Obtaining Unit 53>>

The information obtaining unit 53 of the monitoring apparatus 40 obtains the adjacent connection information 33 created in each node by the exchange of information and the sharing of information between a plurality of nodes that belong to the ring network, and the match information of the topology counter values 35 from the plurality of nodes. The information obtaining unit 53 obtains the adjacent connection information 33 and the match information of the topology counter values 35 from every node that belongs to the ring network. In a case where there is an out-of-ring node, by taking into consideration of a case where out-of-ring nodes are connected in tiers, the adjacent connection information 33 and the match information of the topology counter values 35 are obtained also from the out-of-ring node as necessary.

<<Topology Comparison Unit 54>>

The topology comparison unit 54 of the monitoring apparatus 40 compares a plurality of pieces of adjacent connection information 33 obtained from the plurality of nodes by the information obtaining unit 53 with topology definition information 59 retained in the memory beforehand, and determines whether or not a configuration of the ring network is according to design.

The topology definition information 59 is information that defines the connection relationship between the nodes in the ring network. The topology definition information 59 is information that also defines information of the inter-network node, the inter-network node being the node that connects ring networks to each other. Furthermore, the topology definition information 59 is information that also defines the information of the out-of-ring node.

In this embodiment, the topology definition information 59 is stored in the memory 42 beforehand as the topology definition file 58.

*** Collation Operation in Monitoring Apparatus 40 ***

Collating operation in the monitoring apparatus 40 will be described.

The information obtaining unit 53 of the monitoring apparatus 40 obtains the adjacent connection information 33 and the match information of the topology counter values 35 from every node that belongs to the ring network and the out-of-ring node.

The information obtaining unit 53, by instructions from the control unit 50, transmits a frame that is in accordance with a protocol such as an SNMP and the like to each node device 10 in the network from the message transmission unit 55 of the frame transmission/reception unit 51, via the physical interface unit 52. The information obtaining unit 53 of the monitoring apparatus 40 receives by the message reception unit 56, a response from each node device 10 received from the physical interface unit 52, separates the adjacent connection information 33 for each node device 10 and the match information of the topology counter values 35 from the frame, confirms the match information of the topology counter values 35, and writes the adjacent connection information 33 that each node device 10 has into the connection information file 38.

The monitoring apparatus 40 has the topology definition information 59 set beforehand in the topology definition file 58. According to the instructions from the control unit 50, the monitoring apparatus 40 draws a comparison between the topology definition file 58 and the information stored in the connection information file 38 with the topology comparison unit 54. The topology definition file 58, as with the adjacent connection information 33, may include topology information for each node device 10 and information of the inter-network node and the out-of-ring node of the adjacent ring, may include topology information for each ring ID and information of the inter-network node and the out-of-ring node of the adjacent ring, or may include topology information of the entire multi-ring network.

For each piece of adjacent connection information 33, by comparing the adjacent connection information 33 that each node device 10 of the connection information file 38 has with the topology definition information 59 that the monitoring apparatus 40 has, the topology comparison unit 54 of the monitoring apparatus 40 determines whether or not there is an abnormality.

In a case where there is a discrepancy between the connection information included in the adjacent connection information 33 of every adjacent node adjacent to each node of every node and the connection information included in the topology definition information 59, the topology comparison unit 54 determines that the configuration of the ring network is not according to design.

The information of the inter-network node and the information of the out-of-ring node are also included in the information of the adjacent node that the topology comparison unit 54 compares.

As a specific procedure, in a case where adjacent connection information 33 obtained from node ENm by the information obtaining unit 53 is not included in the information defined in the topology definition information 59, the topology comparison unit 54 determines that the configuration of the ring network is not according to design.

In a case where information of every node ENn that is adjacent to the node ENm that belongs to the ring network is not included, the topology comparison unit 54 determines that the configuration of the ring network is not according to design.

For example, in a case where EN102 and EN108 are defined in the topology definition information 59 as nodes ENn that are adjacent to EN101, but there is no information of EN102 and EN108 in the adjacent connection information 33 as the nodes that are adjacent to EN101, the topology comparison unit 54 determines that the configuration of the ring network is not according to design. Furthermore, in a case where there is a discrepancy between the information of EN102 and EN108 that are in the adjacent connection information 33 and the information of EN102 and EN108 in the topology definition information 59, the topology comparison unit 54 determines that the configuration of the ring network is not according to design.

Specifically, the topology comparison unit 54 of the monitoring apparatus 40 obtains the connection information file 38 and performs a check as follows on a node in the topology definition information 59 of the topology definition file 58, the node being the same as node ENm at the head of the adjacent connection information 33.

Condition 1: Node ENm in the adjacent connection information 33 exists in the topology definition information 59 as node ENm.

Condition 2: An adjacent node count of node ENm in the adjacent connection information 33 and the number of nodes connected to node ENm in the topology definition information 59 match.

Condition 3: Information of serial numbers 4 to 8 relating to an adjacent node of node ENm in the adjacent connection information 33 and information of adjacent node ENn connected to node ENm in the topology definition information 59 match. A check of Condition 3 is repeated for the number of adjacent node counts, the adjacent node count being a count of adjacent nodes that are adjacent to node ENm.

In a case where even one of the conditions is not satisfied, the monitoring apparatus 40 verifies that a topology map abnormality has occurred for node ENm. In a case where Condition 3 is not satisfied, node ENn is managed as a topology map abnormality detection source node of node ENm.

The topology comparison unit 54 manages a node where an abnormality was detected in the adjacent connection information 33 as an abnormality detection source node. Then, the topology comparison unit 54 carries out a check for a next node in the adjacent connection information 33 of the connection information file 38. As described, the check of the topology comparison unit 54 is performed in order on every transmission source ERP node of the connection information file 38 as node ENm.

The adjacent connection information 33, an abnormal state of the adjacent connection information 33, and information on or a state of the abnormality detection source node and the like are reset for every monitoring cycle, and detection is performed by always using the information obtained in a last monitoring cycle.

As described above, the information obtaining unit 53 of the monitoring apparatus 40 obtains from each node, the adjacent connection information 33 created in each node by the exchange of information and the sharing of information between the nodes that belong to the ring network. As described above, the adjacent connection information 33 is the information that indicates a connection relationship between the nodes in the ring network and the out-of-ring node. In this embodiment, the adjacent connection information 33 obtained from each node by the information obtaining unit 53 is saved in the memory 42.

The topology comparison unit 54 of the monitoring apparatus 40 compares the adjacent connection information 33 obtained from each node by the information obtaining unit 53 with the topology definition information 59 retained in the memory 42 beforehand, and determines whether or not configurations of the ring network and the out-of-ring node are according to design. In this embodiment, the topology definition information 59 is stored in the memory 42 beforehand as the topology definition file 58.

*** Description of Effect of Embodiment ***

In this embodiment, whether or not the configuration of the ring network is according to design is determined by a comparison between the adjacent connection information 33 created in each node in the ring network and the topology definition information 59 retained in the memory 42 beforehand. Consequently, according to this embodiment, whether or not the configuration of the ring network is of a desired configuration can be easily confirmed.

In this embodiment, information for determining with a simple method by the monitoring apparatus 40 that an adjacent connection relationship of the rings in the multi-ring network is normal is collected in the node. According to this embodiment, whether or not the adjacent connection information 33 that the nodes in each ring configuring the multi-ring network retain is consistent between the nodes in the ring can be determined by the monitoring apparatus 40 with a simple method.

According to this embodiment, a topology abnormality can be detected by a simple manner, in which the topology definition information 59 that the monitoring apparatus 40 retains and the adjacent connection information 33 that each node generated are collated in the ring network.

*** Other Configurations *** In this embodiment, the functions of the control unit 20 of the node device 10 are realized by software, but as a variation, the functions of the control unit 20 may be realized by hardware. With regard to this variation, differences from this embodiment will mainly be described.

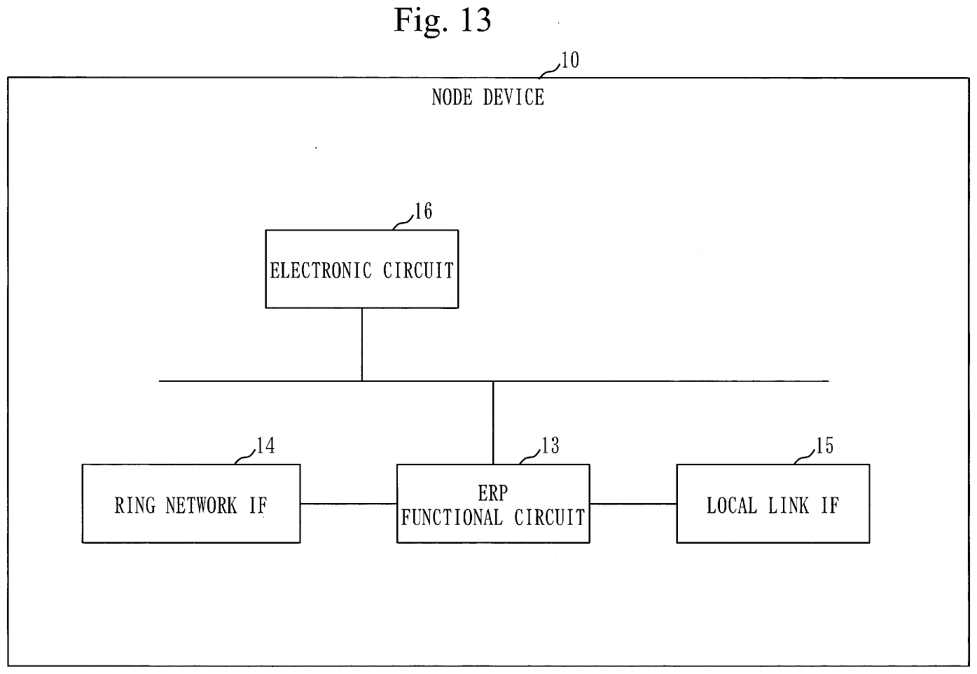

A configuration of the node device 10 according to the variation of this embodiment will be described by referring to FIG. 13.

The node device 10 includes hardware such as an electronic circuit 16, the ERP functional circuit 13, the ring network interface 14, and the local link interface 15.

The electronic circuit 16 is dedicated hardware that realizes the functions of the control unit 20. The electronic circuit 16 is, for example, a single circuit, a composite circuit, a programmed processor, a parallel programmed processor, a logic IC, a GA, an FPGA, an ASIC, or a combination of some or all of these.

The node device 10 may include a plurality of electronic circuits that replace the electronic circuit 16. These plurality of electronic circuits, as a whole, realize the functions of the control unit 20. Each electronic circuit is, for example, a single circuit, a composite circuit, a programmed processor, a parallel programmed processor, a logic IC, a GA, an FPGA, an ASIC, or a combination of some or all of these.

As another variation, the functions of the control unit 20 may be realized by a combination of software and hardware. That is, a part of the functions of the control unit 20 may be realized by dedicated hardware and the rest may be realized by software.

Each of the processor 11 and the electronic circuit 16 is a processing circuitry. That is, even in a case where a hardware configuration of the node device 10 is as the configuration illustrated in either one of FIG. 1 and FIG. 13, operation of the control unit 20 is performed by the processing circuitry.

In this embodiment, the functions of the control unit 50 of the monitoring apparatus 40 are realized by software, but as a variation, the functions of the control unit 50 may be realized by hardware. With regard to this variation, differences from this embodiment will mainly be described.

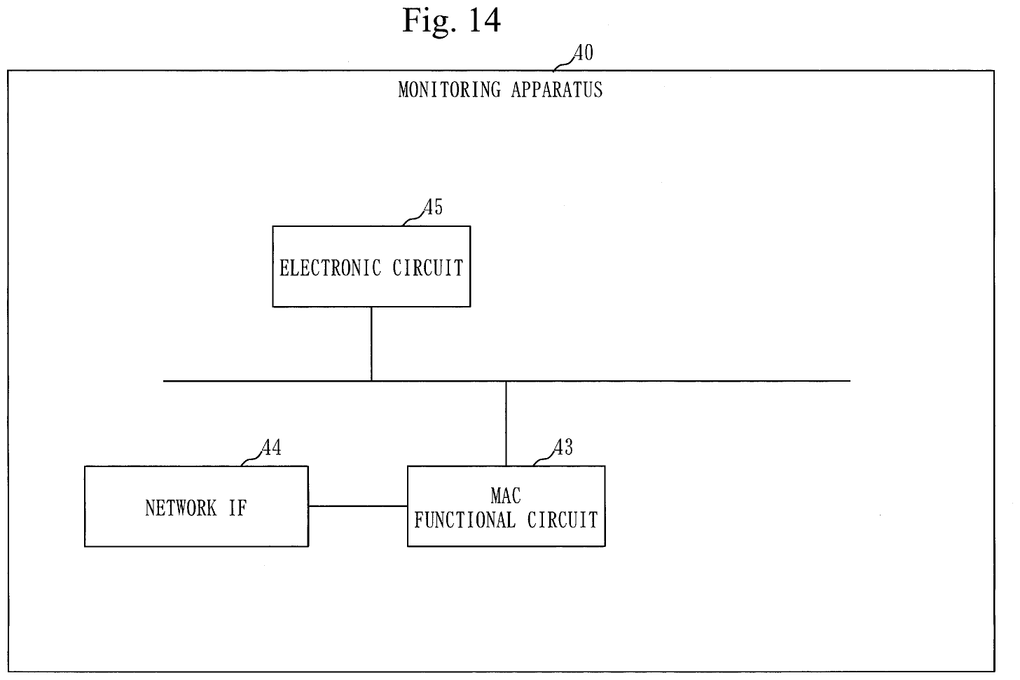

A configuration of a monitoring apparatus 40 according to the variation of this embodiment will be described by referring to FIG. 14.

The monitoring apparatus 40 includes hardware such as an electronic circuit 45, the MAC functional circuit 43, and the network interface 44.

The electronic circuit 45 is dedicated hardware that realizes the functions of the control unit 50. The electronic circuit 45 is, for example, a single circuit, a composite circuit, a programmed processor, a parallel programmed processor, a logic IC, a GA, an FPGA, an ASIC, or a combination of some or all of these.

The monitoring apparatus 40 may include a plurality of electronic circuits that replace the electronic circuit 45. These plurality of electronic circuits, as a whole, realize the functions of the control unit 50. Each electronic circuit is, for example, a single circuit, a composite circuit, a programmed processor, a parallel programmed processor, a logic IC, a GA, an FPGA, an ASIC, or a combination of some or all of these.

As another variation, the functions of the control unit 50 may be realized by a combination of software and hardware. That is, a part of the functions of the control unit 50 may be realized by dedicated hardware and the rest may be realized by software.

Each of the processor 41 and the electronic circuit 45 is a processing circuitry. That is, even in a case where the hardware configuration of the monitoring apparatus 40 is as the configuration illustrated in either one of FIG. 3 and FIG. 14, operation of the control unit 50 is performed by the processing circuitry.

This embodiment is applicable to ring networks other than the ERP network.

### Embodiment 2

In this embodiment, differences from the embodiment described above will be described.

In this embodiment, a configuration of a monitoring apparatus 40 differs from the embodiment described above.

<<<Monitoring Apparatus 40>>>

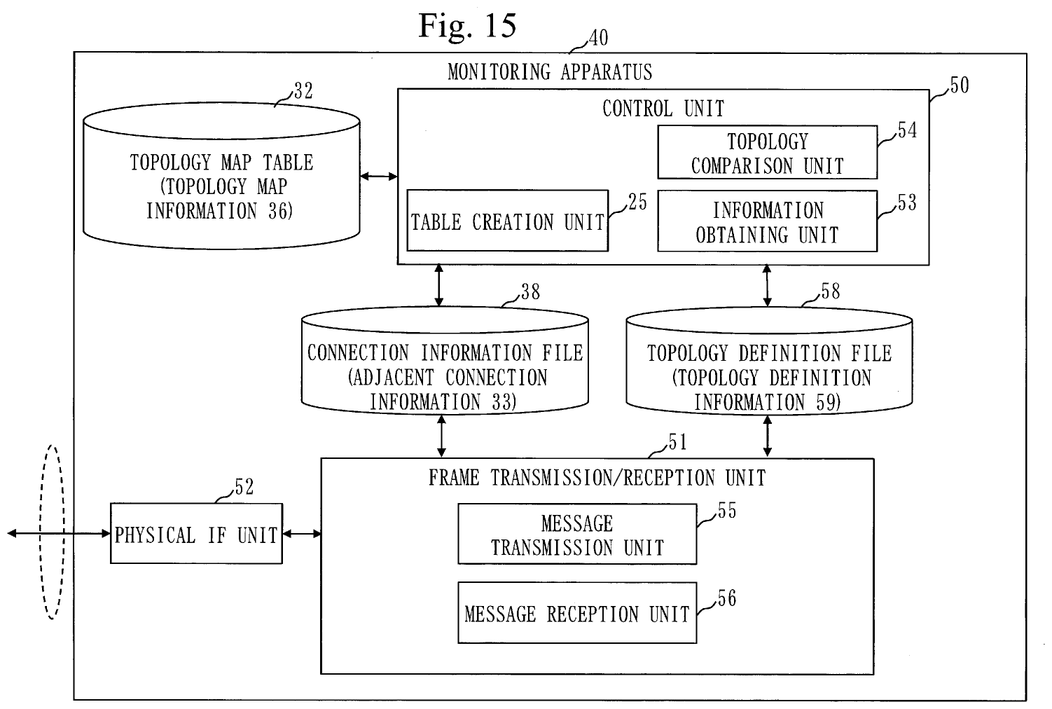

FIG. 15 is a configuration diagram of the monitoring apparatus 40 according to this embodiment.

The monitoring apparatus 40 retains the topology definition information 59 in the memory beforehand.

The topology definition information 59 is information that defines the connection relationship between the nodes in the ring network and the information of the inter-network node, the inter-network node being the node that connects the ring networks to each other.

<<Table Creation Unit 25>>

The monitoring apparatus 40 includes a table creation unit 25.

The table creation unit 25 of the monitoring apparatus 40 has a function to create a topology map table 32. The topology map table 32 is a table in which, as topology information of a ring network that the node device 10 recognized, the information of the ERP node connected to the ring network is recorded.

The table creation unit 25 creates in the topology map table 32, topology map information 36 that indicates the connection relationship between the nodes in the ring network, based on the adjacent connection information 33 of the plurality of nodes stored in the connection information file 38.

The table creation unit 25, furthermore, creates the topology map table 32 having as the topology map information 36, information indicating information of an inter-network node that belongs to a ring network other than the ring network and of the out-of-ring node.

The topology map information 36 is generated based on the plurality of pieces of adjacent connection information 33 obtained from the plurality of nodes by the information obtaining unit 53, and has information as follows.

(1) Connection relationship information between nodes in the ring network and the node information.
(2) Connection relationship information of an inter-network node that belongs to a ring network other than the ring network and node information of the inter-network node.
(3) Connection relationship information of an out-of-ring node that does not belong to the ring network and node information of the out-of-ring node.
(4) Connection relationship information between a plurality of out-of-ring nodes that do not belong to the ring network, and node information of the plurality of out-of-ring nodes.

In this embodiment, the topology map information 36 is saved in the memory 42 as the topology map table 32.

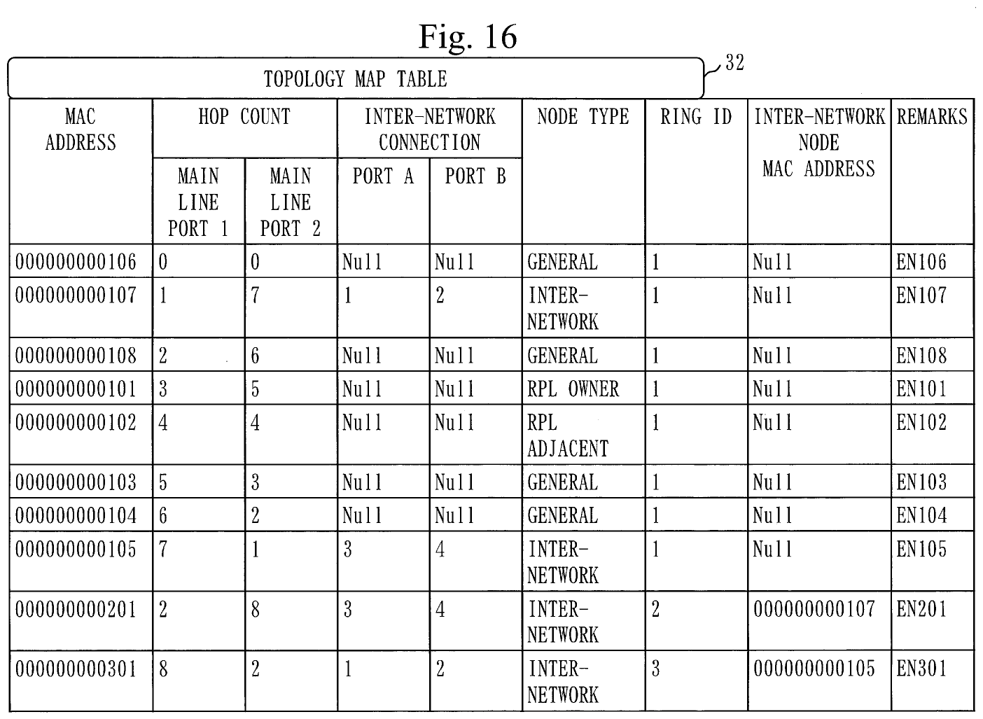

In a case where the ring network is as illustrated in FIG. 7, the table creation unit 25 generates the topology map information 36 as illustrated in FIG. 16 based on the adjacent connection information 33 recorded in the connection information file 38 in order of connection on the main line of the ring.

In the topology map information 36 that the table creation unit 25 generated, connection information of an ERP node with a different ring ID is included. In the example in FIG. 16, connection information of EN201 and EN301 are included. In the topology map table 32 in FIG. 16, EN106 is formed as a starting point. Consequently, “Hop Count” of EN106 for each of “Main Line Port 1” and “Main Line Port 2” is 0. “Main Line Port 1” is a clockwise hop count and “Main Line Port 2” is a counterclockwise hop count in FIG. 5. “Inter-network Connection” is a link aggregation port in a case where “Node Type” is inter-network node. “MAC Address” is a MAC address of each node. “Node Type” is a node type of each node. “Ring ID” is a ring ID set in each node beforehand. “Inter-network Node MAC Address” is a MAC address of an inter-network node to which a node with a different ring ID is connected.

The table creation unit 25 confirms a connection state of each node based on the adjacent connection information 33 recorded in the connection information file 38 and generates the topology map information 36 of the ring network. In the topology map table 32 illustrated in FIG. 16, a connection relationship in a ring, to which eight nodes from EN101 to EN108 are connected, where the ring ID=1 is indicated. A connection relationship between a ring where the ring ID=1 and two nodes, EN201 where the ring ID=2 and EN301 where the ring ID=3, is also indicated. Entries in the topology map table 32 are generated based on nodes having a ring ID of the ring network to where the node device 10 belongs. Entries of nodes with different ring IDs are generated in ascending order of the ring IDs. Then, the table is sorted in a way that the node device 10 is at the top of the table and the hop counts of Port 1 are in ascending order, and the topology map table 32 in FIG. 16 is generated.

<<Topology Comparison Unit 54>>

By comparing in each ring, the topology map information 36 in the topology map table 32 with the topology information that the monitoring apparatus 40 has, the monitoring apparatus 40 determines whether or not there is a topology map abnormality.

The topology comparison unit 54 compares the topology map information 36 with the topology definition information 59, and determines whether or not the configuration of the ring network is according to design.

A specific procedure is as hereinafter described.

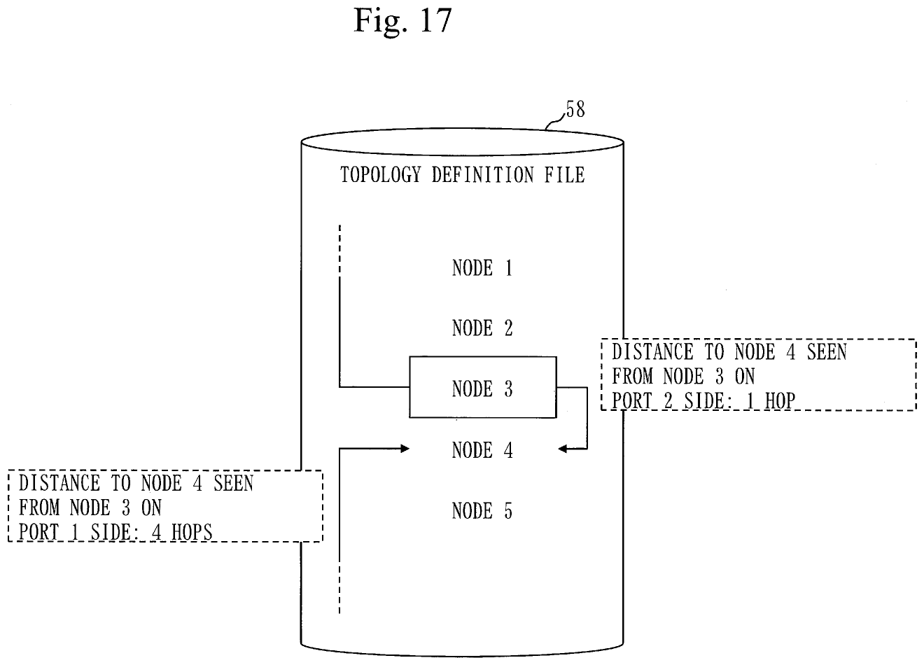

The topology comparison unit 54 of the monitoring apparatus 40 obtains the topology map table 32 and performs a check as illustrated in FIG. 17 on a node in the topology definition information 59 of the topology definition file 58, the node that is the same as node ENm at the top of the topology map table 32. In a case where even one of following conditions is not satisfied, the monitoring apparatus 40 verifies that a topology map abnormality has occurred for node ENm. The check is performed in order on every node in the topology map table 32, each node represented as node ENm.

Condition 1: Node ENm in the topology map table 32 exists in the topology definition information 59 as node ENm.

Condition 2: A distance on a Port 1 side between node ENm and node ENn in the topology definition information 59 is equal to a distance of a node ENm entry on a topology map. A check of Condition 2 is repeated for the number of adjacent node counts, an adjacent node count being a count of adjacent nodes that are adjacent to node ENm.

Condition 3: A distance on a Port 2 side between node ENm and node ENn in the topology definition information 59 is equal to a distance of a node ENm entry on the topology map. A check of Condition 3 is repeated for the number of adjacent node counts, the adjacent node count being a count of adjacent nodes that are adjacent to node ENm.

Node ENn is managed as a topology map abnormality detection source node of node ENm. Then, a check is carried out for a next node in a definition file.

In a case where even one of the conditions is not satisfied, the monitoring apparatus 40 verifies that a topology map abnormality has occurred for node ENm. In a case where Condition 2 or Condition 3 is not satisfied, node ENn is managed as a topology map abnormality detection source node of node ENm.

The topology comparison unit 54 manages a node where an abnormality was detected in the topology map table 32 as an abnormality detection source node. Then, the topology comparison unit 54 carries out a check for a next node in the topology map table 32. As described, the check of the topology comparison unit 54 is performed in order on every node in the topology map table 32, each node represented as node ENm.

As described above, in a case where, between the topology map information 36 and the topology definition information 59, either there is a discrepancy in a distance from node ENn to node ENm in a first direction, or there is a discrepancy in a distance from node ENn to node ENm in a second direction, the second direction being the opposite of the first direction, the topology comparison unit 54 determines that the configuration of the ring network is not according to design.

Information on or a state of the topology map, a topology map abnormal state, the topology map abnormality detection source node, and the like are reset for every monitoring cycle, and detection is performed by always using the information obtained in a last monitoring cycle.

As described above, the table creation unit 25 of the monitoring apparatus 40 creates the topology map information 36.

The topology comparison unit 54 of the monitoring apparatus 40 compares the topology map information 36 with the topology definition information 59 retained in the memory 42 beforehand, and determines whether or not the configuration of the ring network is according to design.

In a case where information of other node ENm defined in the topology definition information 59, the other node ENm being a node that belongs to the ring network, is not included in the topology map information 36 obtained from node ENn by the information obtaining unit 53, the topology comparison unit 54 determines that the configuration of the ring network is not according to design.

In a case where there is a discrepancy in a distance from node ENn to node ENm in the first direction between the topology map information 36 and the topology definition information 59, the topology comparison unit 54 determines that the configuration of the ring network is not according to design.

In a case where there is a discrepancy in a distance from node ENn to node ENm in the second direction, the second direction being the opposite of the first direction, between the topology map information 36 and the topology definition information 59, the topology comparison unit 54 determines that the configuration of the ring network is not according to design.

### REFERENCE SIGNS LIST

10: node device; 11: processor; 12: memory; 13: ERP functional circuit; 14: ring network interface; 15: local link interface; 16: electronic circuit; 20: control unit; 21: ERP functional unit; 22: physical interface unit; 23: physical interface unit; 24: LAN interface unit; 25: table creation unit; 26: node management unit; 27: counter management unit; 28: ERP communication unit; 29: message transmission unit; 30: packet delivery unit; 31: adjacent node information; 32: topology map table; 33: adjacent connection information; 34: topology counter table; 35: topology counter value; 36: topology map information; 38: connection information file; 40: monitoring apparatus; 41: processor; 42: memory; 43: MAC functional circuit; 44: network interface; 45: electronic circuit; 50: control unit; 51: frame transmission/reception unit; 52: physical interface unit; 53: information obtaining unit; 54: topology comparison unit; 55: message transmission unit; 56: message reception unit; 58: topology definition file; 59: topology definition information; 60: network system.

1. A monitoring apparatus comprising:
processing circuitry to:
obtain adjacent connection information
that is created in each node by an exchange of information and sharing of information between a plurality of nodes that belong to a ring network, and
that includes a connection relationship between the nodes in the ring network and information of an inter-network node that belongs to a ring network other than the ring network,
from the plurality of nodes, and
compare connection information included in a plurality of pieces of adjacent connection information obtained from the plurality of nodes with topology definition information, the topology definition information being information that is retained in a memory beforehand and that defines the connection relationship between the nodes in the ring network and the information of the inter-network node that connects the ring networks to each other, and determine whether or not a configuration of the ring network is according to design.

2. The monitoring apparatus according to claim 1,
wherein the processing circuitry
determines that the configuration of the ring network is not according to design in a case where the adjacent connection information obtained from the node does not include information of every single node, wherein the information of every single node is defined in the topology definition information, and each of every single node is a node that is adjacent to the node that belongs to the ring network.

3. The monitoring apparatus according to claim 1,
wherein the processing circuitry
obtains the adjacent connection information from every node that belongs to the ring network, and
determines that the configuration of the ring network is not according to design in a case where there is any discrepancy between connection information included in adjacent connection information of every adjacent node that is adjacent to each node of every node, and connection information included in the topology definition information.

4. The monitoring apparatus according to claim 1,
wherein the processing circuitry
creates topology map information that indicates the connection relationship between the nodes in the ring network and the information of an inter-network node that belongs to a ring network other than the ring network based on the plurality of pieces of adjacent connection information obtained from the plurality of nodes,
compares the topology map information created with the topology definition information, and
determines whether or not the configuration of the ring network is according to design.

5. The monitoring apparatus according to claim 4,
wherein the processing circuitry
determines that the configuration of the ring network is not according to design in a case where, between the topology map information and the topology definition information, either there is a discrepancy in a distance from a node ENn to a node ENm in a first direction, or there is a discrepancy in a distance from the node ENn to the node ENm in a second direction, the second direction being the opposite of the first direction.

6. The monitoring apparatus according to claim 1, wherein
the adjacent connection information further includes information of a node that is connected to the node that belongs to the ring network and that does not belong to a ring network,
the topology definition information further defines information of a node that does not belong to a ring network, and
the processing circuitry compares the connection information included in the plurality of pieces of adjacent connection information obtained from the plurality of nodes with the topology definition information that defines the connection relationship between the nodes in the ring network, the information of the inter-network node that connects the ring networks to each other, and the information of a node that does not belong to a ring network, and determines whether or not a configuration of a network is according to design.

7. A network system comprising:
the monitoring apparatus according to claim 1; and
a plurality of node devices, each of which is a node of the ring network.

8. The network system according to claim 7, wherein
the plurality of node devices perform the exchange of information between nodes adjacent to each other also via a link between, of the nodes that belong to the ring network, a node connected to the inter-network node that belongs to a ring network other than the ring network and the inter-network node.

9. The network system according to claim 7, wherein
the plurality of node devices perform the exchange of information between the nodes adjacent to each other also via a link between, of the nodes that belong to the ring network, a node connected to an out-of-ring node that does not belong to a ring network and the out-of-ring node.

10. The network system according to claim 7, wherein
the plurality of node devices perform the exchange of information between the nodes adjacent to each other via both a block link and remaining links of the links between the nodes adjacent to each other, wherein the block link is a link between an owner node, which is one of the nodes that belong to the ring network, and an adjacent node adjacent to the owner node, and the block link is blocked in a normal condition to avoid a loop.

11. The network system according to claim 7, wherein
the plurality of node devices perform the exchange of information between the nodes adjacent to each other via both a block link and remaining links of the links between the nodes adjacent to each other, wherein the block link is a link between a failure recovery node, which is one of the nodes that belong to the ring network, and an adjacent node adjacent to the failure recovery node, and the block link is blocked at a time of failure recovery to avoid a loop.

12. The network system according to claim 10, wherein
the plurality of node devices perform the sharing of information by notifying each node of the information obtained by the exchange of information via the remaining links excluding the block link.

13. The network system according to claim 10, wherein
the plurality of node devices encode the information obtained by the exchange of information and the sharing of information with a common procedure, notify each node of a code obtained via the remaining links, and in a case where the code obtained in every node that configures the ring network matches each other, determine that a topology is decided upon.

14. A topology management method comprising:
creating, based on information obtained by an exchange of information and sharing of information between a plurality of nodes that belong to a ring network, a plurality of pieces of adjacent connection information that indicate a connection relationship between the nodes in the ring network and information of an inter-network node that belongs to a ring network other than the ring network, by each of a plurality of node devices that is a node of the ring network; and
obtaining the plurality of pieces of adjacent connection information created by the plurality of node devices, comparing connection information included in the plurality of pieces of adjacent connection information obtained with topology definition information retained in a memory beforehand that defines the connection relationship between the nodes in the ring network and the information of the inter-network node that connects the ring networks to each other, and determining whether or not a configuration of the ring network is according to design, by a monitoring apparatus.

15. A non-transitory computer readable medium storing a monitoring program that makes a computer execute:
an information obtaining process to obtain adjacent connection information
that is created in each node by an exchange of information and sharing of information between a plurality of nodes that belong to a ring network, and
that indicates a connection relationship between the nodes in the ring network and information of an inter-network node that belongs to a ring network other than the ring network,
from the plurality of nodes; and
a topology comparison process to compare connection information included in a plurality of pieces of adjacent connection information obtained from the plurality of nodes by the information obtaining process with topology definition information retained in a memory beforehand that defines the connection relationship between the nodes in the ring network and the information of the inter-network node that connects the ring networks to each other, and to determine whether or not a configuration of the ring network is according to design.
